(19) United States
(12) Patent Application Publication
(10) Pub. No.: US 2026/0178249 A1
(43) Pub. Date: Jun. 25, 2026

(54) IMAGE FORMING APPARATUS

(71) Applicant: Toshiba Tec Kabushiki Kaisha, Tokyo (JP)

(72) Inventor: Hiroshi WATANABE, Yokohama Kanagawa (JP)

(21) Appl. No.: 19/338,916

(22) Filed: Sep. 24, 2025

(30) Foreign Application Priority Data
Dec. 20, 2024 (JP) 2024-225664

(51) Int. Cl. G06F 3/12; H04N 1/44

(52) U.S. Cl. CPC G06F 3/1238; G06F 3/1222; G06F 3/1285; H04N 1/4413; H04N 1/4426; H04N 1/4433; H04N 2201/0094

(57) ABSTRACT

According to one embodiment, an image forming apparatus includes a user interface, a memory, a communication interface, and a processor. The user interface receives user information. The memory stores user information. The communication interface communicates with a server storing reference user information. The processor determines that user authentication is successful when first user information input to the user interface and second user information stored in the memory match with each other. After a successful authentication, the processor permits functions of the image forming apparatus to be used and sends a request to the server to check whether the first user information matches the reference user information stored in the server. If a server response to the request indicates the user information does not match the reference user on the server, the use of the one or more functions of the image processing apparatus is ended.

### CROSS-REFERENCE TO RELATED APPLICATION

This application is based upon and claims the benefit of priority from Japanese Patent Application No. 2024-225664, filed Dec. 20, 2024, the entire contents of which are incorporated herein by reference.

### FIELD

Embodiments described herein relate generally to an image forming apparatus.

### BACKGROUND

In the related art, an image forming apparatus having a user authentication function related to restricting one or more apparatus functions for unauthenticated users is known. In this type of image forming apparatus, user information for user authenticating may be managed collectively by an external server associated with the image forming apparatus.

There is also a distributed file system that speeds up access to files by advance caching certain files primarily stored on a server on a client device or the like to permit file access requests to be processed without accessing the server.

In an image forming apparatus having a user authentication function that also adopts caching of a distributed file system, the user authentication process can be speeded up using cached user information. However, when a user information file (user information) on the server side is updated in some manner, there is a problem in that a mismatch occurs between the server side file (user information) and the cached/client side file (user information) stored in the image forming apparatus or the like.

For example, when an identification card (ID card) of a user who is retired from a company or the like is reused as an ID card of a new user, if user information of the retired user still remains in the cache, there is a possibility that the current user of the ID card will be logged in as the retired user such that the image forming apparatus cannot be used appropriately. In addition, since stale user information may remain in the cache, there is a possibility that an ID card that has been deleted (invalidated) on the server side can still be used at the image forming apparatus. In other examples, there is a possibility that a personal identification number (PIN) or the like of a user that has been changed on the server side will not be updated in the cache, so the user cannot pass authentication using the new/updated PIN or the like such that the image forming apparatus cannot be used by the user.

### BRIEF DESCRIPTION OF THE DRAWINGS

FIG. 1 is a diagram illustrating a configuration example of a control system including an image forming apparatus.

FIG. 2 is a diagram illustrating an example of a stand-by screen displayed by a display.

FIG. 3 is a diagram illustrating an example of a top screen displayed by a display.

FIG. 4 is a diagram illustrating an example of user information stored in a storage in a server.

FIG. 5 is a diagram illustrating an example of cached user information stored in an image forming apparatus.

FIG. 6 is a diagram illustrating an example of cached user information stored in an image forming apparatus.

FIG. 7 is a flowchart illustrating a user authentication process of an image forming apparatus.

FIG. 8 is a flowchart illustrating a user authentication process of an image forming apparatus.

FIG. 9 is a flowchart illustrating a user authentication process of an image forming apparatus.

FIG. 10 is a flowchart illustrating a user authentication process of an image forming apparatus.

FIG. 11 is a flowchart illustrating a user authentication process of an image forming apparatus.

FIG. 12 is a flowchart illustrating a user authentication process of an image forming apparatus.

FIG. 13 is a diagram illustrating an example of a setting screen of a to-be-confirmed user function restriction function displayed by a display.

FIG. 14 is a flowchart illustrating an example of an operation of an image forming apparatus.

FIG. 15 is a flowchart illustrating an example of an operation of an image forming apparatus.

### DETAILED DESCRIPTION

Embodiments provide an image forming apparatus that speeds up user authentication and allows user information on a server and cached user information to be matched each other as appropriate.

In general, according to one embodiment, an image forming apparatus includes a user interface configured to receive user information, a memory to store user information, a communication interface configured to communicate with a server storing user information, and a processor. The processor is configured to determine that a user authentication is successful when first user information input via the user interface matches second user information stored in the memory, and then permit use of one or more functions of the image forming apparatus. After a successful authentication, that is, when the first user information matches the second user information, the processor sends a request to the server to check whether the received first user information matches third user information stored in the server. The processor then denies or ends the use of one or more functions of the image forming apparatus when the first user information does not match the third user information. After an unsuccessful authentication, that is, when the first user information does not match the second user information, the processor also sends the request to the server to check whether the received first user information matches the third user information stored in the server. The processor then updates the stored second user information and permits the use of one or more functions of the image forming apparatus when the first user information matches the third user information.

Hereinafter, an image forming apparatus according to certain example embodiments will be described with reference to the drawings. The present disclosure is not limited to an image forming apparatus and aspects may also be applied to another type of information processing apparatus including a user authentication function that incorporates or interacts with an external server.

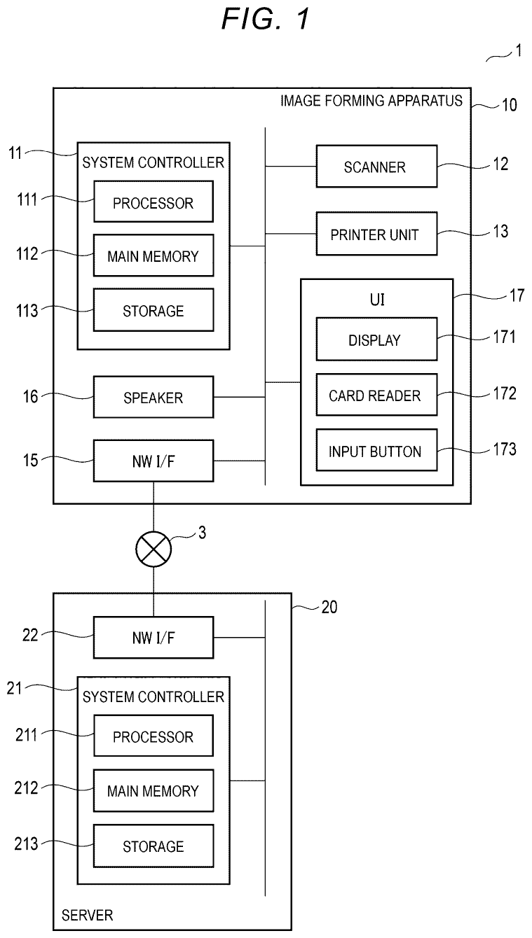

FIG. 1 is a diagram illustrating a configuration example of a control system 1 including an image forming apparatus 10 according to an embodiment.

The control system 1 includes the image forming apparatus 10 and a server 20. The image forming apparatus 10 and the server 20 are communicatively connected to each other through a network 3.

The image forming apparatus 10 is, for example, a multi-function printer (MFP) that executes various processes such as an image forming process while conveying a printing medium. The image forming apparatus 10 is, for example, a solid-state scanning type printer (for example, an LED printer) that scans an LED array to execute various processes such as an image forming process (printing). In addition, the image forming apparatus 10 can be or incorporate an ink jet type printer (ink jet printer) that scans an ink jet head ejecting ink or any other type of printer.

In the present example, the image forming apparatus 10 electrostatically charges a photosensitive drum and then irradiates the photosensitive drum with light corresponding to image data to be printed to form an electrostatic latent image on the photosensitive drum. The image forming apparatus 10 attaches toner to the latent image formed on the photosensitive drum and transfers the toner latent image to a printing medium (e.g., a sheet of paper) to form a toner image on the printing medium. The image forming apparatus 10 then applies heat and pressure to the printing medium such that the toner image is fixed to the printing medium.

The image forming apparatus 10 includes a system controller 11, a scanner 12, a printer unit 13, a communication interface 15, a speaker 16, and a user interface 17. In FIG. 1, the communication interface 15 is abbreviated as “NW I/F”, and the user interface 17 is abbreviated as “UI”. The system controller 11, the scanner 12, the printer unit 13, the user interface 17, and the communication interface 15 are generally accommodated together in a housing or case.

The system controller 11 controls the entire image forming apparatus 10. The system controller 11 includes, for example, a processor 111, a main memory 112, and a storage 113.

The processor 111 is an arithmetic element (for example, CPU: Central Processing Unit) that executes arithmetic processing. The processor 111 executes various processes based on programs or the like stored in the main memory 112. The processor 111 can execute various operations on data, information, and the like by executing the programs stored in the main memory 112.

The main memory 112 includes a nonvolatile memory area and a volatile memory area. The main memory 112 stores an operating system or a program in the nonvolatile memory area. The main memory 112 uses the volatile memory area as a work area where data can be appropriately rewritten by the processor 111. For example, the main memory 112 includes a read only memory (ROM) as the nonvolatile memory area. For example, the main memory 112 includes a random access memory (RAM) as the volatile memory area.

The storage 113 is an auxiliary storage of the image forming apparatus 10. For example, the storage 113 comprises a hard disk drive (HDD). In addition to or instead of the HDD, the storage 113 may include a semiconductor storage medium such as a solid state drive (SSD). The storage 113 stores the above-described program, data used for the processor 111 to execute various processes, and data generated during a process of the processor 111.

For example, the printer unit 13 includes as sub-units a process unit, an exposure unit, a transfer mechanism, a fixing unit, and a conveying unit.

The process unit includes a photosensitive drum, an electrostatic charger, and a developing unit. The photosensitive drum is a photoconductor including a cylindrical drum and a photosensitive layer that is formed on an outer peripheral surface of the drum. The photosensitive drum is rotated by a driving mechanism at a constant speed.

The electrostatic charger uniformly charges a surface of the photosensitive drum. For example, the electrostatic charger applies a voltage to the photosensitive drum using a charging roller such that the photosensitive drum is uniformly charged to a potential having a negative polarity.

The developing unit attaches the toner to the photosensitive drum. The developing unit includes, for example, a developer container, an agitating mechanism, a developing roller, and a doctor blade. The developer container receives and contains the toner supplied from a toner cartridge. The developer container contains a carrier in advance. The toner supplied from the toner cartridge is agitated by the agitating mechanism together with the carrier to form a developer in which the toner and the carrier are mixed. The carrier is stored in the developer container during manufacturing of the developing unit. The developing roller rotates in the developer container such that the developer is attached to the surface. The doctor blade is a member disposed at a predetermined distance from the surface of the developing roller. The doctor blade removes a part of the developer attached to the surface of the rotating developing roller. As a result, a layer of the developer having a thickness corresponding to the distance between the doctor blade and the surface of the developing roller is formed on the surface of the developing roller.

The exposure unit includes a plurality of light emitting elements. The exposure unit forms a latent image on the photosensitive drum by selectively irradiating the charged photosensitive drum with light from the light emitting elements. The light emitting element is, for example, a light emitting diode (LED). One light emitting element is configured to irradiate one point on the photosensitive drum with light. The plurality of light emitting elements are arranged in a main scanning direction that is a direction parallel to a rotation axis of the photosensitive drum. The exposure unit forms a latent image corresponding to one line on the photosensitive drum by irradiating the photosensitive drum with light from the plurality of light emitting elements arranged in the main scanning direction. Further, the exposure unit forms a latent image corresponding to a plurality of lines by irradiating the rotating photosensitive drum with light line-by-line.

In the above-described configuration, when the surface of the photosensitive drum charged by the electrostatic charger is irradiated with light from the exposure unit, an electrostatic latent image is formed. When the layer of the developer formed on the surface of the developing roller approaches the surface of the photosensitive drum, the toner in the developer is attached to the latent image formed on the surface of the photosensitive drum. As a result, a toner image is formed on the surface of the photosensitive drum.

The transfer mechanism is configured to transfer the toner image formed on the surface of the photosensitive drum to the printing medium. The transfer mechanism includes a primary transfer belt, a secondary transfer roller, and a plurality of rollers. The transfer mechanism receives the toner image formed on the surface of the photosensitive drum on an outer peripheral surface of the primary transfer belt. The transfer mechanism conveys the toner image on the outer peripheral surface of the primary transfer belt up to a transfer nip where the secondary transfer roller and the outer peripheral surface of the primary transfer belt are in close contact with each other. The transfer mechanism transfers the toner image on the outer peripheral surface of the primary transfer belt to the surface of the printing medium by allowing the printing medium supplied by the conveying unit to pass through the transfer nip.

The fixing unit is configured to fix the toner image transferred to the surface of the printing medium to the surface of the printing medium. The fixing unit includes: a heating member (heating roller) that applies heat to the printing medium; a pressurizing member (press roller) that applies pressure to the printing medium; and a heater that heats the heating roller. The press roller applies pressure to the heating roller to form a fixing nip where the press roller and the heating roller are in close contact with each other. The fixing unit applies heat and pressure to the printing medium by allowing the printing medium to which the toner image is transferred by the transfer mechanism to pass through the fixing nip. As a result, the fixing unit fixes the toner image formed on the surface of the printing medium. The printing medium that passes the fixing nip is discharged to the outside of the image forming apparatus 10 by the conveying unit.

The conveying unit supplies the printing media (e.g., sheets of paper) from an accommodation unit (e.g., a sheet cassette or tray) one by one to the transfer mechanism and the fixing unit, and discharges the printing medium on which an image has been formed to a discharge tray outside of the housing of the image forming apparatus 10.

The scanner 12 is provided, for example, in a main body upper portion of the image forming apparatuses 10. The scanner 12 optically reads an image of a document or the like. For example, the scanner 12 reads an image of a document set on a document table (platen) glass. In addition, the scanner 12 may also be configured to read an image of a document that is conveyed by an automatic document feeder (ADF).

The communication interface 15 is for communication with the server 20 through the network 3.

The speaker 16 generates a sound corresponding to an audio signal.

The user interface 17 includes a display 171, an input button 173, and a card reader 172. The display 171 can display an image and can receive an input of an instruction based on a user operation on the display 171. The display 171 includes a display device that can display an image. The display device is, for example, a liquid crystal display 171 or an organic electroluminescence (organic EL) display 171 but is not limited thereto. The display 171 includes an input device that is stacked on the display device and can receive an input of an instruction based on a user touch or the like on the display 171.

The input button 173 can be a button that can be physically pressed by a user (that is, a mechanical button or the like). The input button 173 is an interface through which an instruction based on a user operation can be input.

The card reader 172 reads information from a card incorporating a recording medium that stores information including a card ID (e.g., a card ID number). The card may be a magnetic stripe type card, a contact type IC card, or a contactless type IC card. User information read from the card by the card reader 172 is supplied to the processor 111.

The image forming apparatus 10 has a user authentication function. The image forming apparatus 10 stores, for example, a program for executing the user authentication function in the main memory 112. The user authentication function executes an user authentication based on user information input through the user interface 17. Such user information may be, for example, a user name, a password, a card ID, and/or a PIN. For example, the card ID is read from a card presented by a user to the card reader 172. The user name, the password, and the PIN are input by the user, for example, using the display 171 and the input button 173.

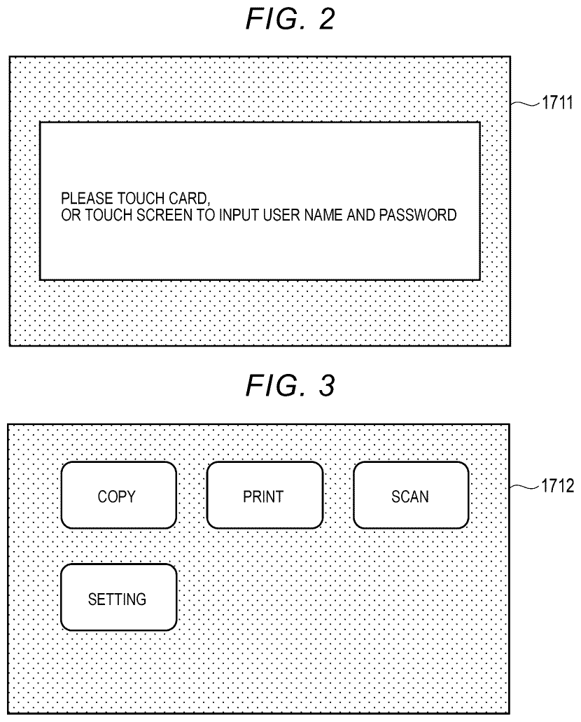

FIG. 2 is a diagram illustrating an example of a stand-by screen 1711 displayed by the display 171. When the user authentication function is enabled but a user is not yet authenticated, the processor 111 causes the display 171 to display the stand-by screen 1711. The stand-by screen 1711 displays information (e.g., text) that urges a user who wants to use the image forming apparatus 10 to perform user authentication operations. The stand-by screen 1711 displays, for example, a text “PLEASE TOUCH CARD, OR TOUCH SCREEN TO INPUT USER NAME AND PASSWORD”.

While the stand-by screen 1711 is being displayed by the display 171, the processor 111 of this example will not accept an operation for using any function of the image forming apparatus 10. That is, in a state where the stand-by screen 1711 is displayed, the image forming apparatus 10 is in a state in which user authentication is required. Examples of the functions of the image forming apparatuses 10 include a copying function using the scanner 12 and printer unit 13, a print function for printing a designated file on a printing medium using printer unit 13, a scanning function of reading a document using the scanner 12, and a setting function permitting the changing of various print and/or device settings of the image forming apparatus 10.

In a state where the stand-by screen 1711 is displayed by the display 171, the user presents a card to the card reader 172. As a result, the user information is transmitted to the processor 111, and the processor 111 starts a user authentication process for authenticating the user based on the user information. In addition, the user may touch the stand-by screen 1711 to transition the display 171 to an input screen. In this context, the input screen is a screen via which a manual input of user information can be received by the operation of the display 171 and/or the input button 173. When the input screen is displayed by the display 171, the user information is input by the display 171 and the input button 173. As a result, user information is transmitted to the processor 111, and the processor 111 starts a user authentication process for authenticating the user based on the input user information.

FIG. 3 is a diagram illustrating an example of a top screen 1712 (top menu) displayed by the display 171. In FIG. 3, the top screen 1712 is displayed on the display 171. On the top screen 1712 depicted in FIG. 3, a “copy” button for transition to a screen for using the copying function, a “print” button for transition to a screen for using the print function, a “scan” button for transition to a screen for using the scanning function, and a “setting” button for transition to a screen for using the setting function are arranged. Once the user is authenticated, the processor 111 causes the display 171 to display the top screen 1712. The top screen 1712 is the first screen that is displayed after the user is authenticated by the user authentication function. In a state where the top screen 1712 is displayed by the display 171, the processor 111 can receive an operation for selecting a function of the image forming apparatus 10 to use.

Referring back to FIG. 1, the server 20 is connected to the network 3, and can communicate with the image forming apparatus 10 through the network 3. The server 20 includes a system controller 21, a memory, and a communication interface 22. In FIG. 1, the communication interface 22 is abbreviated as “NW I/F”. The system controller 21 and the communication interface 22 are accommodated in a housing or the like.

The system controller 21 controls the entire server 20. The system controller 21 includes, for example, a processor 211, a main memory 212, and a storage 213.

The processor 211 is an arithmetic element (for example, CPU) that executes arithmetic processing. The processor 211 executes various processes based on programs stored in the main memory 212. The processor 211 can execute various operations by executing the programs stored in the main memory 212.

The main memory 212 includes a nonvolatile memory area and a volatile memory area. The main memory 212 stores an operating system or a program in the nonvolatile memory area. The main memory 212 uses the volatile memory area as a work area where data is appropriately rewritten by the processor 211. For example, the main memory 212 includes a read only memory (ROM) as the nonvolatile memory area. For example, the main memory 212 includes a random access memory (RAM) as the volatile memory area.

The storage 213 corresponds to an auxiliary storage part of the server 20. For example, the storage 213 includes a hard disk drive (HDD). In addition to or instead of the HDD, the storage 213 may include a semiconductor storage medium such as a solid state drive (SSD). The storage 213 stores programs, data used for the processor 211 to execute various processes, and data generated during a process of the processor 211.

The communication interface 22 is an interface for communication with the image forming apparatus 10 through the network 3.

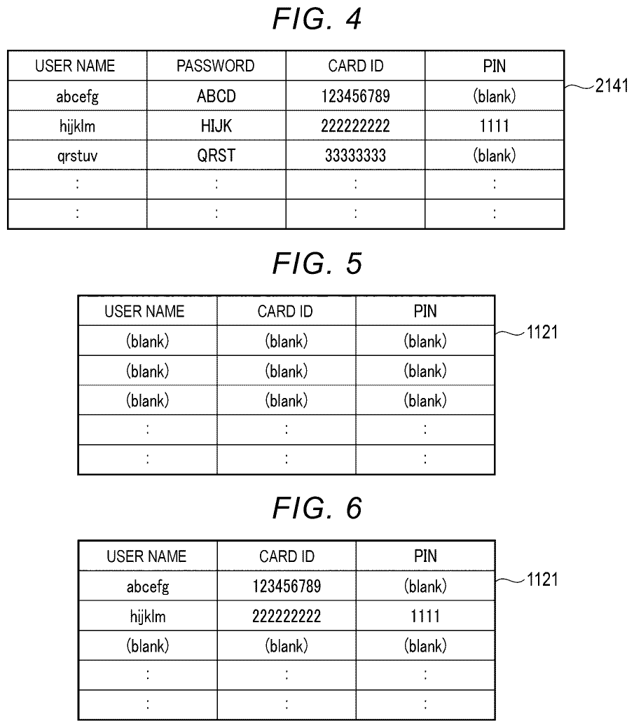

FIG. 4 is a diagram illustrating an example of user information stored in the storage 213 in the server 20. The storage 213 includes a user information database 2141. The user information database 2141 stores the user information for various users. A record of the user information for each user in the user information database 2141 includes a user name, a password, a card ID, and a PIN. The user name is information representing the name of the user. The password is information used for confirming whether the user is the registered person himself or herself. The card ID is identification information for uniquely identifying the card of the user. The PIN can be information corresponding to the card ID.

In the user information database 2141 of FIG. 4, “abcefg”, “hijklm”, and “qrstuv” are registered as the user names. For example, in the record of the user name “abcefg”, “ABCD” is registered as the password, and “123456789” is registered as the card ID. In the record of the user name “abcefg”, “(blank)” is provided in the PIN entry. Here, the “(blank)” entry/value represents that no corresponding information has been registered.

FIGS. 5 and 6 are diagrams illustrating an example of user information stored as a cache in the main memory 112 in the image forming apparatus 10. The main memory 112 includes a user information database 1121 where the user information can be cached. In the user information database 1121, a user name, a card ID, and a PIN may be registered.

FIG. 5 illustrates the user information database 1121 before any user information is cached from the server 20. In the user information database 1121 of FIG. 5, no values for the user name, the card ID, and the PIN are registered, and thus entries are all shown as “(blank)”.

FIG. 6 illustrates the user information database 1121 after user information has been cached from the server 20. Specifically, the user information database 1121 in FIG. 6 is in a state where user information regarding the user names “abcefg” and “hijklm” have been cached. User information regarding the user name “qrstuv” has not been cached, and thus is not registered in the user information database 1121 of FIG. 6.

When the power of the image forming apparatus 10 is turned off, the user information database 1121 stored in the main memory 112 may be stored in the storage 113. When the power of the image forming apparatus 10 is turned on, the user information database 1121 stored in the storage 113 may be read to the main memory 112.

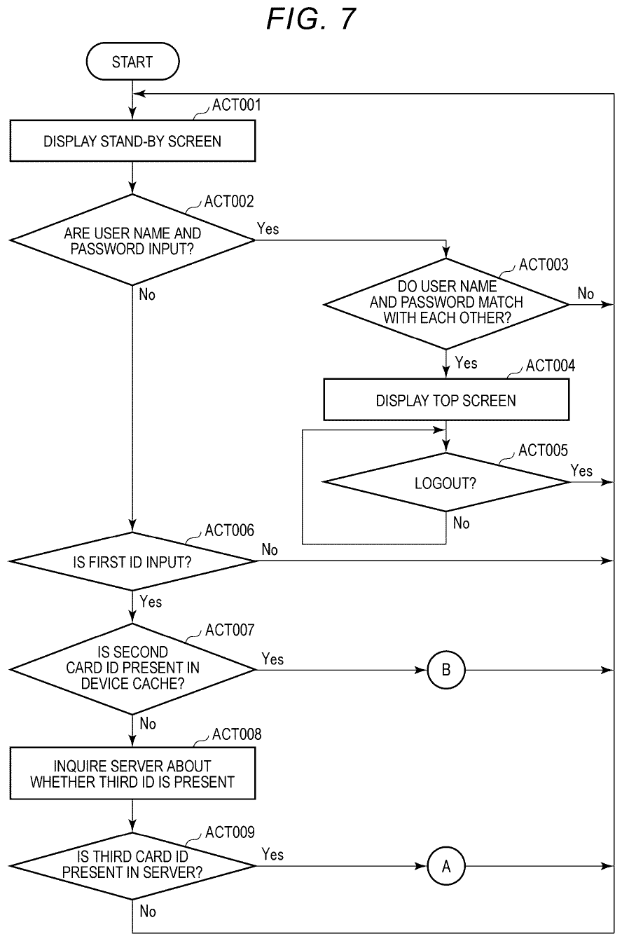

An operation related to the user authentication process of the image forming apparatus 10 will be described. FIGS. 7 to 12 are flowcharts illustrating operations related to the user authentication process of the image forming apparatus 10. For easier understanding of the description, user information input from the user interface 17 will be referred to as first user information, user information registered in the user information database 1121 of the image forming apparatus 10 will be referred to as second user information, and user information registered in the user information database 2141 of the server 20 will be referred to as third user information. In addition, the values of items in a record of the first user information will be referred to using the following convention, a “first [item]” such as a user name in the first user information will be referred to as a “first user name”. Likewise, the values of items in records of the second user information and the third user information will be referred to as “second [item]” and “third [item]”.

First, the description will be made with reference to FIG. 7. In a state where the user authentication function is enabled and the user is not yet authenticated, the processor 111 causes the display 171 to display the stand-by screen 1711 (ACT001). The processor 111 displays the stand-by screen 1711 or the input screen until a first user name and first password are input (ACT002) or a first card ID is input (ACT006).

When the first user name and the first password are input, the processor 111 transmits the input first user name and first password to the server 20. The server 20 compares the received first user name and first password to the third user names and the third passwords of the user information database 2141. When the first user name and the first password match with a third user name and a third password, the server 20 transmits a signal indicating a match with a third user name and a third password to the image forming apparatus 10. When the first user name and the first password do not match with a third user name and a third password, the server 20 transmits a signal indicating that the first user name and the first password do not match with a third user name and a third password to the image forming apparatus 10. When the signal indicating no match is received (ACT003, No), the processor 111 displays the stand-by screen 1711. When the signal indicating a match is received (ACT003, Yes), the processor 111 displays the top screen 1712 as a user authentication completion (ACT004). When the logout of a user whose user authentication was previously completed is detected, the processor 111 causes the display 171 to display the stand-by screen 1711 (ACT005, Yes).

The description will be made with reference to FIG. 7. When the first card ID is input from the card reader 172 (ACT006, Yes), the processor 111 checks whether there is a second card ID that matches with the first card ID in the user information database 1121 of the main memory 112 (ACT007). When a second card ID that matches with the first card ID is not present in the user information database 1121 of the main memory 112 (ACT007, No), the processor 111 transmits an inquiry about whether there is a third card ID that matches the first card ID in the user information database 2141 of the server 20 (ACT008).

When a signal is received from the server 20 indicating that a third card ID that matches with the first card ID is not present (ACT009, No), the processor 111 causes the display 171 to display the stand-by screen 1711. When a signal is received from the server 20 indicating that a third card ID that matches with the first card ID is present (ACT009, Yes), the processor 111 caches the third card ID and the third PIN associated with the third card ID from the server 20 to the user information database 1121 of the main memory 112 (ACT101). Further, when the third PIN is registered (not blank) for the third card ID and included in the signal received from the server 20 (ACT102, No), the processor 111 causes the display 171 to display an input screen for inputting a PIN (ACT103).

An example will be described with reference to FIG. 4. When a card ID “222222222” is received from the card reader 172, the processor 111 transmits the card ID to the server 20. When the card ID “222222222” is present in the user information database 2141, the server 20 transmits a signal to the image forming apparatus 10 indicating an answer that the card ID is “present” and that the associated PIN is “1111”. When the card ID received from the server 20 is “123456789”, the server 20 transmits a signal to the image forming apparatus 10 indicating an answer that the card ID is “present” and the associated PIN is “(blank)”.

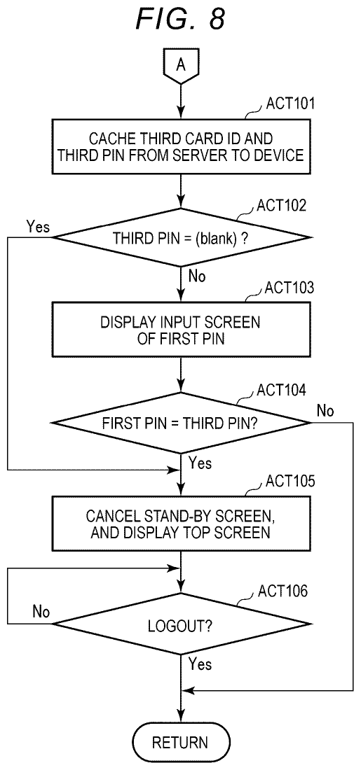

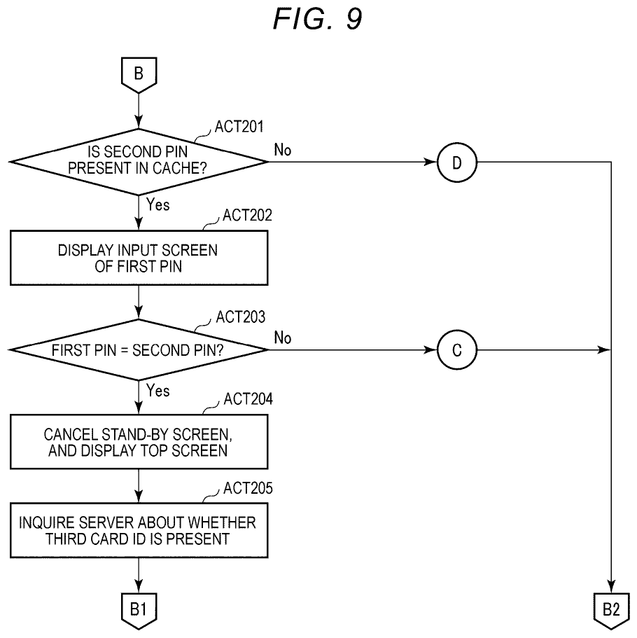

The description will be made with reference to FIG. 8. When the input first PIN does not match with the third PIN (ACT104, No), the processor 111 causes the display 171 to display the stand-by screen 1711. When the input first PIN matches with the third PIN (ACT104, Yes), the processor 111 displays the top screen 1712 as user authentication completion (ACT105). In addition, when the third card ID matches with the first card ID and the third PIN is “(blank)” (ACT102, Yes), the processor 111 displays the top screen 1712 as user authentication completion (ACT105). When the logout of a user whose user authentication was previously completed is detected, the processor 111 causes the display 171 to display the stand-by screen 1711 (ACT106, Yes).

The description will be made with reference to FIG. 9. When a second card ID that matches with the first card ID is present in the user information database 1121 (ACT007, Yes), the processor 111 checks whether an associated second PIN is registered in the user information database 1121 (ACT201). When the second PIN is in the user information database 1121 (ACT201, Yes), the processor 111 causes the display 171 to display an input screen for inputting the PIN (ACT202). When the input first PIN matches with the second PIN (ACT203, Yes), the processor 111 displays the top screen 1712 as user authentication completion (ACT204). After this, the processor 111 transmits an inquiry about whether a third card ID that matches with the first card ID is present in the user information database 2141 of the server 20 (ACT205).

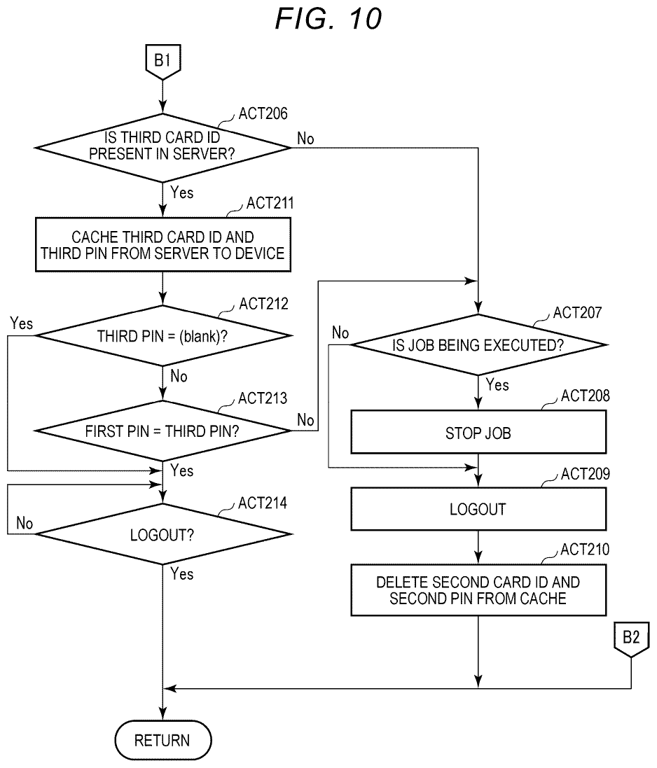

The description will be made with reference to FIG. 10. When a signal is received from the server 20 indicating that a third card ID that matches with the first card ID is not present (ACT206, No), the processor 111 checks whether a job is being executed (ACT207). When a job is being executed (ACT207, Yes), the processor 111 stops the job (ACT208). The job is, for example, image formation by the printer unit 13 or document reading by the scanner 12. After the job is stopped (ACT208) or when the job is not being executed (ACT207, No), the processor 111 logs out the user whose user authentication was previously completed (ACT209). Next, the processor 111 deletes the second card ID that was used for the user authentication as well as the second PIN from the user information database 1121 (ACT210). After the logout is detected, the processor 111 causes the display 171 to display the stand-by screen 1711.

When a signal is received from the server 20 indicating that a third card ID that matches with the first card ID is present (ACT206, Yes), the processor 111 caches the third card ID that matches with the first card ID and the third PIN associated with the third card ID from the server 20 to the user information database 1121 of the main memory 112 (ACT211). Further, when the third card ID that matches with the first card ID is present and the third PIN is registered in the signal received from the server 20 (ACT212, No), the processor 111 checks whether the first PIN input in ACT202 matches with the third PIN (ACT213). When the first PIN does not match with the third PIN (ACT213, No), the processor 111 proceeds to the process of ACT207. When the first PIN input in ACT202 matches with the third PIN (ACT213, Yes), the processor 111 maintains the user authentication. In addition, when the third card ID that matches with the first card ID is present and the third PIN is “(blank)” in the signal received from the server 20 (ACT212, Yes), the processor 111 maintains the user authentication. When a logout is detected, the processor 111 causes the display 171 to display the stand-by screen 1711 (ACT214, Yes).

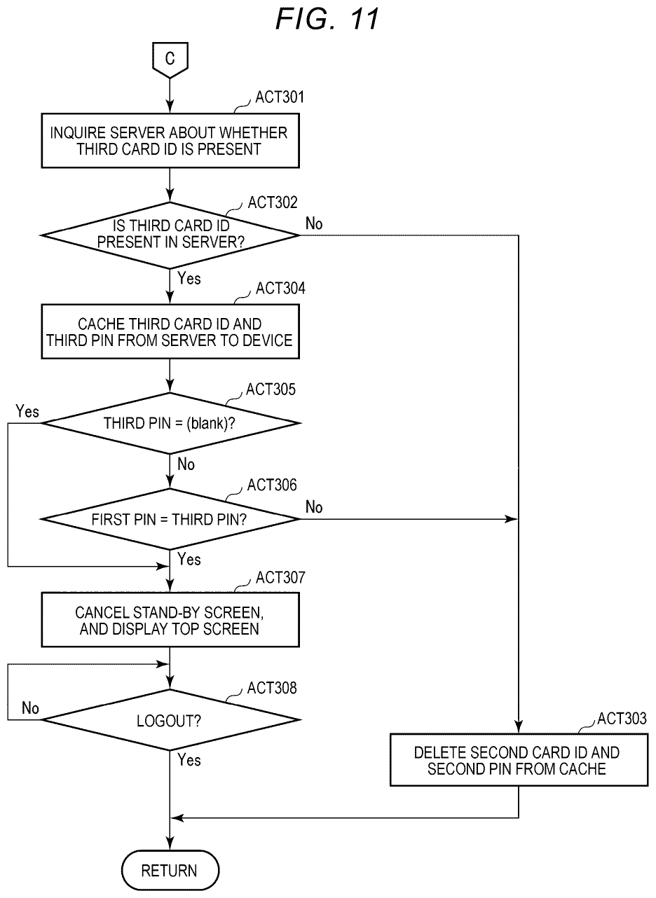

The description will be made with reference to FIG. 11. When the first PIN input in ACT202 does not match with the second PIN (ACT203, No), the processor 111 transmits an inquiry about whether the third card ID that matches with the first card ID is present in the user information database 2141 of the server 20 (ACT301). When a signal is received from the server 20 indicating that a third card ID that matches with the first card ID is not present (ACT302, No), the processor 111 deletes the second card ID that matched with the first card ID input in ACT006 and the second PIN that was associated with the second card ID from the user information database 1121 of the main memory 112 (ACT303). Next, the processor 111 causes the display 171 to display the stand-by screen 1711.

When a signal is received from the server 20 indicating that the third card ID that matches with the first card ID is present (ACT302, Yes), the processor 111 caches the third card ID that matches with the first card ID and the third PIN associated with the third card ID from the server 20 to the user information database 1121 of the main memory 112 (ACT304). Further, when the third card ID that matches with the first card ID is present and the third PIN is registered in the signal received from the server 20 (ACT305, No), the processor 111 checks whether the first PIN input in ACT202 matches with the third PIN (ACT306). When the first PIN does not match with the third PIN (ACT306, No), the processor 111 proceeds to the process of ACT303. When the first PIN matches with the third PIN (ACT306, Yes), the processor 111 displays the top screen 1712 as user authentication completion (ACT307). When a logout is detected, the processor 111 causes the display 171 to display the stand-by screen 1711 (ACT308, Yes).

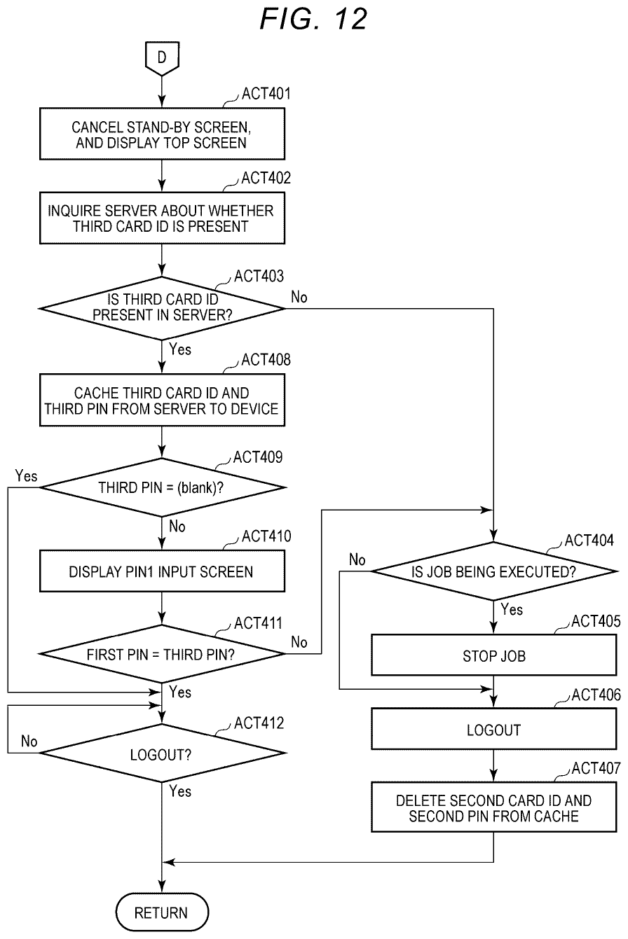

The description will be made with reference to FIG. 12. When the second card ID that matches with the first card ID is present in the user information database 1121 (ACT007, Yes) and the second PIN is not registered in the user information database 1121 (ACT201, No), the processor 111 displays the top screen 1712 as user authentication completion (ACT204). Next, the processor 111 transmits an inquiry about whether a third card ID that matches with the first card ID is present in the user information database 2141 of the server 20 (ACT402).

When a signal is received from the server 20 indicating that the third card ID that matches with the first card ID is not present (ACT403, No), the processor 111 checks whether a job is being executed (ACT404). When the job is being executed (ACT404, Yes), the processor 111 stops the job (ACT405). When the job is stopped (ACT405) or when the job is not being executed (ACT404, No), the processor 111 logs out the user whose user authentication was previously completed (ACT406). Next, the processor 111 deletes the second card ID used for the user authentication and the second PIN associated with the second card ID from the user information database 1121 of the main memory 112 (ACT407). When a logout is detected, the processor 111 causes the display 171 to display the stand-by screen 1711.

When a signal is received from the server 20 indicating that the third card ID that matches with the first card ID is present (ACT403, Yes), the processor 111 caches the third card ID that matches with the first card ID and the third PIN associated with the third card ID from the server 20 to the user information database 1121 of the main memory 112 (ACT408). Further, when the third card ID that matches with the first card ID is present and the third PIN is registered in the signal received from the server 20 (ACT409, No), the processor 111 causes the display 171 to display an input screen for inputting the PIN (ACT410). When the input first PIN does not match with the third PIN (ACT411, No), the processor 111 proceeds to the process of ACT404. When the input first PIN matches with the third PIN (ACT411, Yes), the processor 111 maintains the user authentication state. When the third card ID that matches with the first card ID is present and the third PIN is “(blank)” in the signal received from the server 20 (ACT409, Yes), the processor 111 also maintains the user authentication state. When a logout is detected, the processor 111 causes the display 171 to display the stand-by screen 1711 (ACT412, Yes).

When the processor 111 inquires of the server 20 about whether the third card ID is present, if the third card ID is not present in the user information database 2141 of the server 20, the processor 111 may notify the user of the absence of the third card ID by emitting a beep sound from the speaker 16 or by causing the display 171 to display a message.

As described above, the image forming apparatus 10 according to the present embodiment determines that user authentication is successful when first user information input to the user interface 17 and second user information stored in the memory match with each other, inquires of the server 20 about whether the first user information and third user information (stored in the server 20) match with each other, and control the second user information to be deleted from the memory when a signal is received indicating that the first user information and the third user information do not match with each other. Further, when the signal indicating that the first user information and the third user information do not match with each other is received, the image forming apparatus 10 transitions to a state in which user authentication is required. Further, when the signal indicating that the first user information and the third user information do not match with each other is received during execution of a job, the image forming apparatus 10 stops the job.

The image forming apparatus 10 can speed up user authentication while still allowing user information cached on the image forming apparatus 10 to be updated as necessary to match with the user information on the server 20.

Further, in the present embodiment, a to-be-confirmed user function restriction may be provided. With a to-be-confirmed user function restriction, when user authentication is completed based on the first user information and the second user information and the image forming apparatus 10 then inquires of the server 20 about whether a third card ID that matches with the first card ID is present in the user information database 2141 (for example, ACT205 and ACT402), full functionality of the image forming apparatus 10 may be restricted while waiting for an answer to the inquiry. That is, some but not all functions of the image forming apparatus 20 may be made available to the user during the interim period before full confirmation using the third card ID information and the like on the server 20.

For example, the image forming apparatus 10 stores a program for executing the to-be-confirmed user function restriction in the main memory 112. For the to-be-confirmed user function restriction, when user authentication is completed based on the first user information and the second user information and then the image forming apparatus 10 inquires of the server 20 about whether a third card ID that matches with the first card ID is present in the user information database 2141, a function of the image forming apparatus 10 may be restricted while waiting for an answer to the inquiry.

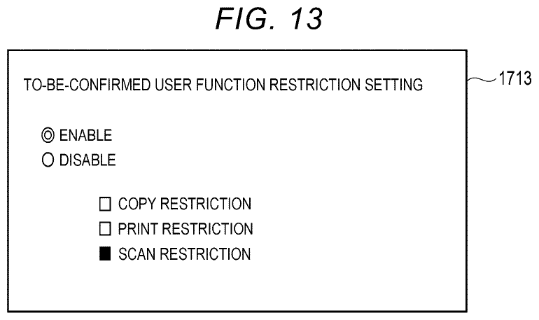

FIG. 13 is a diagram illustrating an example of a to-be-confirmed user function restriction setting screen 1713 displayed by the display 171. On the to-be-confirmed user function restriction setting screen 1713 in FIG. 13, a radio button for setting whether inquiry-to-be-confirmed user function restriction is to be enabled or disabled is displayed. In the depicted example, “ENABLE” is selected. In addition, check boxes for restricting particular functions of the image forming apparatus 10 are displayed. In the depicted example, “SCAN RESTRICTION” is selected (checked). That is, by setting the inquiry-to-be-confirmed user function restriction as illustrated in FIG. 13, when user authentication is completed based on the first user information and the second user information and then a confirmation inquiry is transmitted to the server 20, the processor 111 may accept an operation for using the copying function and/or the print function but does not accept an operation for using the scanning function while waiting for an answer to the inquiry from the server 20.

During the to-be-confirmed user function restriction period, for example, the button of a restricted function displayed on the top screen 1712 may be grayed out to prevent selection of a restricted function selected. Alternatively, the button for a restricted function may be excluded from display on the top screen 1712.

The to-be-confirmed user function restriction is set, for example, by a user who has the administrator authority over the image forming apparatus 10. The setting of the to-be-confirmed user function restriction may be applied to all of the users who use the image forming apparatus 10 a or may be individually applied to particular users or classes of users.

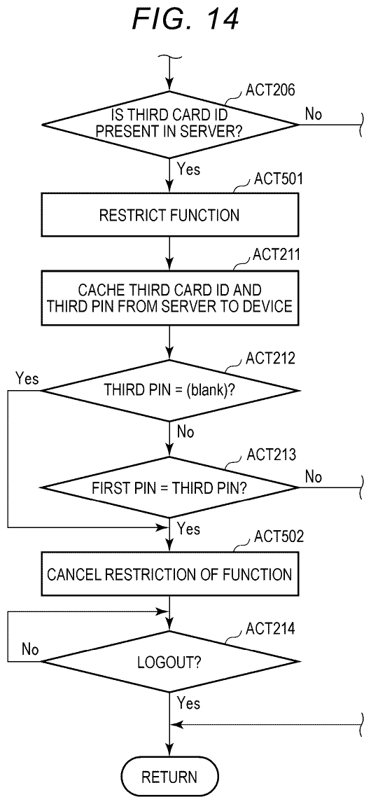

FIG. 14 is a flowchart illustrating an example of the operation of the image forming apparatus 10 when the to-be-confirmed user function restriction is enabled. FIG. 14 is a flowchart where the processes when the to-be-confirmed user function restriction is enabled are added focusing on the portion of ACT206, ACT211, and ACT214 in FIG. 10. The processes in FIG. 10 not specifically included in FIG. 14 are the same as in FIG. 10.

The description will be made with reference to FIG. 14. When a signal is received from the server 20 indicating that the third card ID that matches with the first card ID is present (ACT206, Yes), the processor 111 restricts one or more functions of the image forming apparatus 10 as selected to be restricted in the to-be-confirmed user function restriction settings(ACT501). The processor 111 caches the third card ID and the third PIN associated with the third card ID from the server 20 to the user information database 1121 (ACT211). When a third card ID that matches with the first card ID is present and the third PIN is registered in the signal received from the server 20 (ACT212, No), the processor 111 then checks whether the first PIN input in ACT202 matches with the third PIN (ACT213). When the first PIN does not match with the third PIN (ACT213, No), the processor 111 proceeds to the process of ACT207. When the first PIN input in ACT202 matches with the third PIN (ACT213, Yes), the processor 111 cancels the restriction of the function(s) of the image forming apparatus 10 (ACT502), and maintains the user authentication. In addition, when a third card ID that matches with the first card ID is present and the third PIN is “(blank)” in the signal received from the server 20 (ACT212, Yes), the processor 111 cancels the restriction of the function of the image forming apparatus 10 (ACT502), and maintains the user authentication. When a logout is detected, the processor 111 causes the display 171 to display the stand-by screen 1711 (ACT214, Yes).

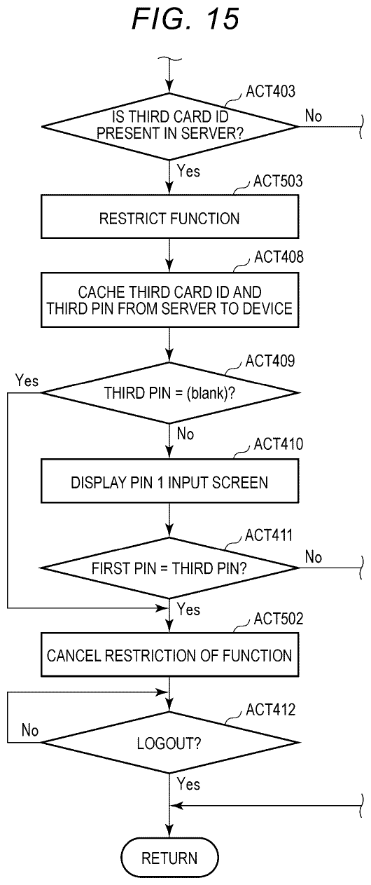

FIG. 15 is a flowchart illustrating an example of the operation of the image forming apparatus 10 when the to-be-confirmed user function restriction is enabled. FIG. 15 is a flowchart where the processes when the to-be-confirmed user function restriction function is enabled are added focusing on the portion of ACT403, ACT408, and ACT412 of FIG. 12. The processes of FIG. 12 not specifically illustrated in FIG. 15 are the same as that illustrated in FIG. 12.

The description will be made with reference to FIG. 15. When a signal is received from the server 20 indicating that the third card ID that matches with the first card ID is not present (ACT403, Yes), the processor 111 restricts the function(s) of the image forming apparatus 10 as selected to be restricted in the to-be-confirmed user function restriction settings (ACT503). The processor 111 caches the third card ID and the third PIN associated with the third card ID from the server 20 to the user information database 1121 (ACT408). Further, when a third card ID that matches with the first card ID is present and the third PIN is registered in the signal received from the server 20 (ACT409, No), the processor 111 causes the display 171 to display an input screen for inputting the PIN (ACT410). When the input first PIN does not match with the third PIN (ACT411, No), the processor 111 proceeds to the process of ACT404. When the input first PIN matches with the third PIN (ACT411, Yes), the processor 111 cancels the restriction of the function(s) of the image forming apparatus 10 (ACT504) and maintains the user authentication. In addition, when a third card ID that matches with the first card ID is present and the third PIN is “(blank)” in the signal received from the server 20 (ACT409, Yes), the processor 111 cancels the restriction of the function(s) of the image forming apparatus 10 (ACT504) and maintains the user authentication. When a logout is detected, the processor 111 causes the display 171 to display the stand-by screen 1711 (ACT412, Yes).

As described above, in the image forming apparatus 10, when user authentication is completed based on the first user information and the second user information and the image forming apparatus 10 then inquires of the server 20 about whether a third card ID that matches with the first card ID is present in the user information database 2141, a function of the image forming apparatus 10 can be restricted while waiting for an answer to the inquiry.

### Modification Examples

In the image forming apparatus 10 according to the an embodiment, the method of caching a part of the user information of the server 20 into the main memory 112 is used. In a modification example, replicas of all of the user information on the server 20 may be stored in the main memory 112. That is, all of the user information stored in the user information database 2141 of the server 20 can be stored in the main memory 112 instead of caching just the third card IDs (and associated third PINs) that has been recently matched to an input first card ID and first PIN. Specifically, in ACT101, ACT211, ACT304, and ACT408 in the flowcharts of the image forming apparatus 10 according to an embodiment, all of the user information stored in the user information database 2141 of the server 20 is transferred and stored in the main memory 112.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a user interface configured to receive user information;
a memory to store user information;
a communication interface configured to communicate with a server storing user information; and
a processor configured to:
determine that a user authentication is successful when first user information input via the user interface matches second user information stored in the memory, and then permit use of one or more functions of the image forming apparatus,
after a successful authentication when the first user information matches the second user information, send a request to the server to check whether the received first user information matches third user information stored in the server, and deny the use of one or more functions of the image forming apparatus when the first user information does not match the third user information, and
after an unsuccessful authentication when the first user information does not match the second user information, send the request to the server to check whether the received first user information matches the third user information stored in the server, and update the stored second user information and permit the use of one or more functions of the image forming apparatus when the first user information matches the third user information.

2. The image forming apparatus according to claim 1, wherein when a response to the check whether the received first information matches the third user information stored in the server indicates a non-match, the processor transitions the image forming apparatus to a state where user authentication is required.

3. The image forming apparatus according to claim 2, wherein, when the response indicates the non-match, and the response is received during execution of a print job, the processor stops the execution of the print job.

4. The image forming apparatus according to claim 1, wherein the user interface includes a card reader.

5. The image forming apparatus according to claim 4, wherein the user interface further includes a display screen.

6. The image forming apparatus according to claim 5, wherein the user interface further includes a touch panel integrated with the display screen.

7. The image forming apparatus according to claim 1, wherein the first user information is input via a card reader of the user interface.

8. The image forming apparatus according to claim 1, wherein the first user information is a user name and password.

9. The image forming apparatus according to claim 1, wherein the user interface includes a touch panel integrated with the display screen.

10. The image forming apparatus according to claim 9, wherein the processor is configured to cause the display screen to display a standby screen via which the first user information can be input before a successful authentication and to display a top menu screen via which one or more functions of the image forming apparatus can be accessed after a successful authentication.

11. A printer access control system, comprising:
a server connected to a network and storing reference user information; and
a printer connectable to the network, the printer including:
a user interface configured to receive user information;
a memory storing local reference user information;
a communication interface configured to communicate with the server across the network; and
a processor configured to:
determine that a user authentication is successful when first user information input via the user interface matches the local reference user information stored in the memory and then permit use of one or more functions of the printer,
after a successful authentication when the first user information matches the local reference user information, send a request to the server to check whether the received first user information matches the reference user information stored in the server, and deny the use of one or more functions of the printer when the first user information does not match the reference user information stored on the server, and
after an unsuccessful authentication when the first user information does not match the local reference user information, send the request to the server to check whether the received first user information matches the reference user information stored on the server, and update the stored local reference user information and permit the use of one or more functions of the image forming apparatus when the first user information matches the reference user information stored on the server.

12. The printer access control system according to claim 11, wherein when a response to the check whether the received first information matches the reference user information stored in the server indicates a non-match, the processor transitions the printer to a state where user authentication is required again.

13. The printer access control system according to claim 12, wherein, when the response indicates the non-match, and the response is received during execution of a print job, the processor stops the execution of the print job.

14. The printer access control system according to claim 11, wherein the user interface includes a card reader.

15. The printer access control system according to claim 14, wherein the user interface further includes a display screen and a touch panel integrated with the display screen.

16. The printer access control system according to claim 15, wherein the processor is configured to cause the display screen to display a standby screen via which the first user information can be input before a successful authentication and to display a top menu screen via which one or more functions of the printer can be accessed after a successful authentication.

17. A printer access control method, comprising:
determining that a user authentication is successful when first user information input via a user interface of a printer matches local reference user information stored in the memory of the printer and then permit use of one or more functions of the printer;
after a successful authentication when the first user information matches the local reference user information, send a request to a server to check whether the received first user information matches reference user information stored in the server, and deny the use of one or more functions of the printer when the first user information does not match the reference user information stored on the server; and
after an unsuccessful authentication when the first user information does not match the local reference user information, send the request to the server to check whether the received first user information matches the reference user information stored on the server, and update the stored local reference user information and permit the use of one or more functions of the image forming apparatus when the first user information matches the reference user information stored on the server.

18. The printer access control method according to claim 17, wherein when a response to the check whether the received first information matches the reference user information stored in the server indicates a non-match, the processor transitions the printer to a state where user authentication is required again.

19. The printer access control method according to claim 18, wherein, when the response indicates the non-match, and the response is received during execution of a print job, the processor stops the execution of the print job.

20. The printer access control method according to claim 17, further comprising:
causing a display screen of the printer to display a standby screen via which the first user information can be input before a successful authentication; and
causing the display screen to transition from the standby screen to a top menu screen via which one or more functions of the printer can be accessed after a successful authentication.
